(19) United States
(12) Patent Application Publication
(10) Pub. No.: US 2026/0302022 A1
(43) Pub. Date: Oct. 1, 2026

(54) Magnetic Fluid Composition

(71) Applicant: SEIKO EPSON CORPORATION, Tokyo (JP)

(72) Inventors: Shigeki KAWADA, Shiojiri (JP); Daisuke ISHIHARA, Matsumoto (JP); Takeshi YANO, Fujimi (JP)

(21) Appl. No.: 19/576,145

(22) Filed: Mar. 24, 2026

(30) Foreign Application Priority Data
Mar. 25, 2025 (JP) 2025-049328

(51) Int. Cl. H01F 1/44

(52) U.S. Cl. CPC H01F 1/442; H01F 1/445

(57) ABSTRACT

Provided is a magnetic fluid composition including: a metal magnetic particle; and a magnetic ionic liquid, in which the ionic liquid includes a cationic group and an anionic group, the cationic group is a metallocene ion, a central metal of the metallocene ion is one selected from the group including V, Cr, Mn, Fe, Co, and Ru, and the anionic group is one or more selected from the group including a tetrafluoroborate ion, a hexafluorophosphate ion, a trifluoromethanesulfonate ion, and a bis(trifluoromethanesulfonyl)amide ion.

The present application is based on, and claims priority from JP Application Serial Number 2025-049328, filed Mar. 25, 2025, the disclosure of which is hereby incorporated by reference herein in its entirety.

### BACKGROUND

### 1. Technical Field

The present disclosure relates to a magnetic fluid composition.

### 2. Related Art

A magneto rheological fluid (also referred to as an “MR fluid”) is a fluid in which metal magnetic particles are dispersed in a dispersion medium such as mineral oil or silicone oil. When a magnetic field is applied to the magneto rheological fluid, the metal magnetic particles are magnetized and arranged in a magnetic field direction, forming chain-shaped clusters, which changes the viscosity of the fluid. A formation strength of the chain-shaped clusters depends on a magnitude of the magnetic field to be applied, and the viscosity can be varied by changing the magnitude of the magnetic field.

When the magnetic field is removed, the magnetization of the metal magnetic particles is released, the chain-shaped clusters return to an original non-oriented state, and the viscosity also returns to an original state. The viscosity of the fluid can be adjusted by repeating application and removal of the magnetic field to or from the magneto rheological fluid or changing the strength of the magnetic field. Therefore, the magneto rheological fluid is considered for use in a variety of fields, including control devices such as linear dampers and rotary dampers, and braking devices such as brakes and clutches.

A high braking force is required for the magneto rheological fluid used in the braking devices. A temperature range in which the magneto rheological fluid is used is assumed to be from minus several tens of degrees to several hundreds of degrees, and it is required that physical properties can be maintained not only at a room temperature but also at a low temperature or a high temperature.

For example, JP-T-2010-504635 discloses a method of using an ionic liquid as a dispersion medium as a solution to prevent evaporation of a magneto rheological fluid, assuming that the magneto rheological fluid is used at a high temperature of 200° C.

JP-T-2010-504635 is an example of the related art.

As the range of applications of the magneto rheological fluid expands, there is a demand for a magneto rheological fluid that not only has a high braking force but is also less likely to be affected by a surrounding environmental temperature.

### SUMMARY

The present disclosure has been made in view of the above circumstances, and an object thereof is to provide a magnetic fluid composition that can implement a high braking force and is less likely to be affected by a surrounding environmental temperature.

[1] A magnetic fluid composition including: a metal magnetic particle; and a magnetic ionic liquid, in which the ionic liquid contains a cationic group and an anionic group, the cationic group is a metallocene ion, a central metal of the metallocene ion is one selected from the group including V, Cr, Mn, Fe, Co, and Ru, and the anionic group is one or more selected from the group including a tetrafluoroborate ion, a hexafluorophosphate ion, a trifluoromethanesulfonate ion, and a bis(trifluoromethanesulfonyl)amide ion.

[2] The magnetic fluid composition according to [1], in which the central metal is Fe.

[3] The magnetic fluid composition according to [1] or [2], in which the anionic group is a tetrafluoroborate ion or a hexafluorophosphate ion.

[4] The magnetic fluid composition according to any one of [1] to [3], in which the ionic liquid has an ionic strength of less than 6 mol/L.

[5] The magnetic fluid composition according to any one of [1] to [4], in which the magnetic fluid composition has a yield stress of 15 kPa or more when being applied with a magnetic field of 0.6 T.

[6] The magnetic fluid composition according to any one of [1] to [5], in which the magnetic fluid composition has a boiling point of 250° C. or higher.

According to the present disclosure, a magneto rheological fluid that can implement a high braking force and is less likely to be affected by a surrounding environmental temperature can be provided.

### DESCRIPTION OF EMBODIMENTS

### Magnetic Fluid Composition

The present disclosure is a magnetic fluid composition including metal magnetic particles and a magnetic ionic liquid.

Although the dispersion medium of the magnetic fluid composition is not magnetic in the related art, it has been found that the magnetic fluid composition exhibits a high braking force by applying magnetism to the ionic liquid which is a dispersion medium by the investigation by the inventors of the present disclosure.

In addition, it has been found that a magnetic fluid composition using an ionic liquid in which a specific cationic group and a specific anionic group are combined has an improved boiling point and can implement a high braking force even in a high-temperature environment.

Each component will be described below.

### Metal Magnetic Particles

The metal magnetic particles in the present specification are particles containing, as a forming material, a metal material exhibiting paramagnetism. The metal magnetic particles are a paramagnetic material as a whole. A material constituting the magnetic particles contains a metal element, and preferably contains at least one metal element selected from the group including Fe, Ni, and Co.

The above metal element may be contained in the magnetic metal particles as a magnetic alloy, a magnetic metal oxide, a magnetic metal nitride, or a magnetic metal carbide.

The materials constituting the metal magnetic particles may contain an element other than Fe, Ni, and Co, and specific examples thereof include Al, Si, S, Sc, Ti, V, Cu, Y, Mo, Rh, Pd, Ag, Sn, Sb, Te, Ba, Ta, W, Re, Au, Bi, La, Ce, Pr, Nd, P, Zn, Sr, Zr, Mn, Cr, Nb, Pb, Ca, B, C, and N. Specific examples of the materials constituting the metal magnetic particles include alloys such as an Fe—Co-based alloy (preferably permendur), an Fe—Ni-based alloy (preferably permalloy), an Fe—Zr-based alloy, an Fe—Mn-based alloy, an Fe—Si-based alloy, an Fe—Al-based alloy, a Ni—Mo-based alloy (preferably supermalloy), an Fe—Ni—Co-based alloy, an Fe—Si—Cr-based alloy, an Fe—Si—B-based alloy, an Fe—Si—Al-based alloy (preferably sendust), an Fe—Si—B—C-based alloy, an Fe—Si—B—Cr-based alloy, an Fe—Si—B—Cr—C-based alloy, an Fe—Co—Si—B-based alloy, an Fe—Si—B—Nb-based alloy, an Fe nano crystal alloy, an Fe-based amorphous alloy, and a Co-based amorphous alloy, and ferrite such as spinel ferrite (preferably Ni—Zn-based ferrite or Mn—Zn-based ferrite) and hexagonal ferrite (preferably barium ferrite).

The above alloy may be an amorphous alloy.

Among them, the amorphous alloy is preferable, and the Fe—Si—B—Cr—C-based alloy, the Fe-based amorphous alloy, the Fe—Si—Cr-based alloy, the Fe nano crystal alloy, the Fe—Ni—Co-based alloy, the Co-based amorphous alloy, and the Ni—Mo-based alloy are more preferable.

The materials constituting the metal magnetic particles may be used alone or in combination of two or more types.

A content ratio of the metal magnetic particles in the magnetic fluid composition is, for example, 50% by mass or more and 99% by mass or less and 60% by mass or more and 90% by mass or less with respect to a total mass of the magnetic fluid composition.

The above content ratio is a total content ratio of two or more types of metal composite particles when two or more types of metal magnetic particles are contained.

### Ionic Liquid

The magnetic fluid composition includes a magnetic ionic liquid as the dispersion medium. The ionic liquid has a higher affinity with the metal magnetic particles than that with the mineral oil, and using the ionic liquid in the dispersion medium makes it less likely for the magnetic fluid composition to separate.

The ionic liquid contains a cationic group and an anionic group.

The cationic group is a metallocene ion.

The anionic group is one or more selected from the group including a tetrafluoroborate ion, a hexafluorophosphate ion, a trifluoromethanesulfonate ion, and a bis(trifluoromethanesulfonyl)amide ion.

Whether the braking force of the magnetic fluid composition is stable in a high-temperature environment is likely to depend on the boiling point of the ionic liquid which is the dispersion medium.

The magnetic fluid composition including the ionic liquid in which the above cationic group and anionic group are combined has a high boiling point of, for example, 250° C. or higher, and can exert a high braking force.

The cationic group and the anionic group will be described below.

### Cationic Group

The cationic group is a metallocene ion.

The metallocene ion is an organometallic compound including the central metal and two cyclopentadienyl rings (Cp rings).

In the present specification, the “metallocene” includes an unsubstituted metallocene and a substituted metallocene.

In the present specification, the “unsubstituted metallocene” is a metallocene including a cyclopentadienyl group as a ligand.

In the present specification, the “substituted metallocene” is a metallocene including a substituted cyclopentadienyl group as a ligand.

In the embodiment, the central metal included in the metallocene ion is one selected from the group including V, Cr, Mn, Fe, Co, and Ru. Since the ionic liquid includes the cationic group including these paramagnetic transition metals, the ionic liquid is magnetic.

In the embodiment, examples of the cationic group include a vanadocene ion, a chromocene ion, a manganocene ion, a ferrocene ion, a corocene ion, and a luteenocene ion.

An example of the metallocene ion that can be used in the embodiment is represented by the following formula (A)-1.

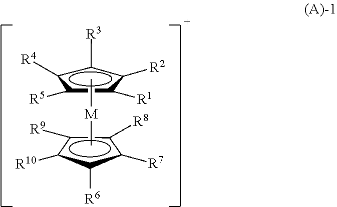

In the formula (A)-1, R¹ to R¹⁰ each independently represents a hydrogen atom, a linear, branched, or annular alkyl group having 1 to 10 carbon atoms, an (aminoethyl)aminomethyl group, a dodecylmethylenedimethylammonium group, a bis(1,1-dimethylethyl)phosphino group, a dimethylaminomethyl group, a diphenylphosphino group, and a diphenylphosphinoisopropyl group.

Examples of the alkyl group include a methyl group, an ethyl group, an n-propyl group, an isopropyl group, an n-butyl group, a tert-butyl group, an n-pentyl group, and an n-hexyl group.

In Formula (A)-1, M is one selected from the group including V, Cr, Mn, Fe, Co, and Ru. M is preferably one selected from the group including Mn, Fe, Co, and Ru, and more preferably Fe.

That is, the cationic group is preferably a ferrocene ion.

### Anionic Group

The anionic group is one or more selected from the group including a tetrafluoroborate ion, a hexafluorophosphate ion, a trifluoromethanesulfonate ion, and a bis(trifluoromethanesulfonyl)amide ion.

These bulky anionic groups disperse thermal energy and are less likely to interact with the cationic group, and thus are less likely to thermally decomposed. From the viewpoint of obtaining a stable magnetic fluid composition even at a high temperature, the anionic group forming the ionic liquid is preferably a tetrafluoroborate ion or a hexafluorophosphate ion.

The dispersion medium is preferably formed of the ionic liquid, and the dispersion medium may contain additives other than the ionic liquid in a range of not impairing the effects of the present disclosure. Examples of such an additive include thixotropic agents, surfactants, plastic media, and water-in-oil emulsions.

A content ratio of the ionic liquid with respect to the total amount of the magnetic fluid composition is preferably 18 by mass or more and 50% by mass or less, and more preferably 10% by mass or more and 30% by mass or less.

When the content ratio of the ionic liquid is in the above range, a high braking force can be implemented even in a high-temperature environment.

In one aspect of the present disclosure, the ionic liquid preferably has an ionic strength of less than 6 mol/L, and more preferably 5.5 mol/L or less.

When an ionic liquid having a low ionic strength is used, the boiling point of the magnetic fluid composition can be further improved, and a high braking force can be exerted even in the high-temperature environment of, for example, 250° C. or higher.

The ionic strength of the ionic liquid can be calculated by the following method.

### Method of Calculating Ionic Strength of Ionic Liquid

Ionic strengths of the anion and the cation is calculated by the following method.

$$ionic strength [ mol / L ] of anion = addition amount [ g / L ] / density [ g / mol ]$$

$$Ionic strength [ mol / L ] of cation = addition amount [ g / L ] / density [ g / mol ]$$

The ionic strength of the anion is represented by “A”, the ionic strength of the cation is represented by “C”, and the ionic strength of the ionic liquid is calculated by the following formula.

$$Ionic strength of ionic liquid [ mol / L ] = 1 / 2 \times ( {A}^{2} + {C}^{2} )$$

### Physical Properties of Magnetic Fluid Composition

The magnetic fluid composition has a yield stress of preferably 15 kPa or more and more preferably 20 kPa or more when being applied with a magnetic field of 0.6 T.

The magnetic fluid composition preferably has a boiling point of 250° C. or higher, more preferably 300° C. or higher, and still more preferably 350° C. or higher.

In one aspect of the present disclosure, the magnetic fluid composition preferably has a freezing point of 0° C. or lower, more preferably −10° C. or lower, and still more preferably −20° C. or lower.

The boiling point, freezing point, and yield stress of the magnetic fluid composition can be measured by the following methods.

### Method of Measuring Boiling Point

The magnetic fluid composition (2 mL) was heated on a hot plate, a temperature at which white smoke was generated was confirmed and evaluated according to the following criteria. Among the following criteria, if the criteria met AA, A, or B, it was evaluated that “the magnetic fluid composition has a high boiling point”.
AA: No evaporation up to 350° C.
A: No evaporation up to 300° C.
B: No evaporation up to 250° C.
C: Evaporated at less than 250° C.

### Method of Measuring Freezing Point

The magnetic fluid composition (2 mL) was cooled by a refrigerator, and a solidification temperature was confirmed and evaluated according to the following criteria. Among the following criteria, if the criteria met A or B, it was evaluated that “the magnetic fluid composition has a low freezing point”.
A: Solidify at −20° C. or lower
B: Solidify at higher than −20° C. and 0° C. or lower
C: Solidify at higher than 0° C. and 10° C. or lower

### Method for Measuring Yield Stress

At 250° C., the yield stress of the magnetic fluid composition when being applied with a magnetic field having a shear stress of 333/sec and a magnetic flux density of 0.6 T was measured and evaluated according to the following criteria. Among the following criteria, if the criteria met AA, A, or B, it was evaluated that “the magnetic fluid composition has a high braking force”.
AA: 40 kPa or more
A: 25 kPa or more and less than 40 kPa
B: 15 kPa or more and less than 25 kPa
C: 10 kPa or more and less than 15 kPa

### Method of Producing Magnetic Fluid Composition

The magnetic fluid composition according to the embodiment can be produced by mixing and stirring the metal magnetic particles and the magnetic ionic liquid at a desired ratio.

### EXAMPLES

### Method of Producing Magnetic Ionic Liquid

Equimolar amounts of each ferrocene compound and each anion silver salt were ground together in an agate mortar and allowed to react. The solid silver after the reaction was removed by filtration, and a filtrate of the magnetic ionic liquid was recovered. Thereafter, a product was heated at 100° C. for 1 hour.

The ionic strength of the ionic liquid was calculated by the method described in the above [method of calculating ionic strength of ionic liquid].

### Production of Magnetic Fluid Composition

Magnetic fluid compositions of Examples 1 to 10 and Comparative Examples 1 to 9 were produced by mixing metal magnetic particles and magnetic ionic liquids indicated in Tables 1 to 5 at the following ratios and stirring them under the following conditions.

### Mixing Ratio

Metal magnetic particles: 80% by mass
Ionic liquid: 20% by mass

### Stirring Conditions

Stirring was performed at 3000 rpm for 30 minutes using a high shear mixer (Silverson, L5M-A).

The boiling point, the freezing point, and the yield stress of the magnetic fluid composition were measured and evaluated by the following methods.

### Boiling Point

Measurement was performed by the method described in the above [method of measuring boiling point].

### Freezing Point

Measurement was performed by the method described in the above [method of measuring freezing point].

### Yield Stress

Measurement was performed by the method described in the above [method of measuring yield stress].

### Comprehensive Evaluation

The evaluation of boiling point, freezing point, and yield stress was comprehensively performed according to the following items.
X: only AA and A
Y: there is no C, but there are one or more B
Z: there is at least one C

TABLE 1

| | Items | Example 1 | Example 2 | Example 3 | Example 4 |
|---|---|---|---|---|---|
| Metal | Magnetic | Fe, Si, B, C, Cr | Fe, Si, B, C, Cr | Fe, Si, B, C, Cr | Fe, Si, B, C, Cr |
| magnetic | powder | | | | |
| particles | Steel type | Amorphous alloy | Amorphous alloy | Amorphous alloy | Amorphous alloy |
| | Concentration | 80% | 80% | 80% | 80% |
| | wt % | | | | |
| Ionic liquid | Cation | Ferrocenyl | Tert-butylferrocene | Butyl ferrocene | Ferrocene |
| | | methylethylenediamine | | | |
| | | CAS number: | CAS number: | CAS number: | CAS number: |
| | | 130859-06-2 | 1316-98-9 | 31904-29-7 | 102-54-5 |
| | Anion | Trifluoromethane | Tetrafluoroboric | Hexafluorophosphoric | Bis(trifluorometh- |
| | | sulfonic acid | acid | acid | anesulfonyl)imide |
| | | CAS number: | CAS number: | CAS number: | CAS number: |
| | | 1493-13-6 | 14104-20-2 | 26042-63-7 | 189114-61-2 |
| | Concentration | 20% | 20% | 20% | 20% |
| | wt % | | | | |
| | Ionic strength | 7.4 | 6.0 | 5.7 | 9.4 |
| | mol/L | | | | |
| Physical | Boiling point | B | B | B | B |
| Properties of | Freezing point | B | B | A | B |
| Magnetic Fluid | Yield stress | B | B | A | A |
| Composition | Comprehensive | Y | Y | Y | Y |
| | evaluation | | | | |

TABLE 2

| | Items | Example 5 | Example 6 | Example 7 |
|---|---|---|---|---|
| Metal | Magnetic | Fe, Si, B, C, Cr | Fe, Si, B, C, Cr | Fe, Si, B, C, Cr |
| magnetic | powder | | | |
| particles | Steel type | Amorphous alloy | Amorphous alloy | Amorphous alloy |
| | Concentration | 80% | 80% | 80% |
| | wt % | | | |
| Ionic liquid | Cation | 1,1′-dibutylferrocene | Ferrocene-methyl dodecyl | Bis(pentamethylcyclo- |
| | | | dimethylammonium | pentadienyl)iron(II) |
| | | CAS number: | CAS number: | CAS number: |
| | | 1274-08-4 | 98778-40-6 | 12126-50-0 |
| | Anion | Trifluoromethanesulfonic | Tetrafluoroboric | Hexafluorophosphoric |
| | | acid | acid | acid |
| | | CAS number: | CAS number: | CAS number: |
| | | 1493-13-6 | 14104-20-2 | 26042-63-7 |
| | Concentration | 20% | 20% | 20% |
| | wt % | | | |
| | Ionic strength | 7.6 | 5.5 | 5.2 |
| | mol/L | | | |
| Physical | Boiling point | B | B | B |
| Properties of | Freezing point | A | A | A |
| Magnetic Fluid | Yield stress | A | A | A |
| Composition | Comprehensive | Y | Y | Y |
| | evaluation | | | |

TABLE 3

| | Items | Example 8 | Example 9 | Example 10 |
|---|---|---|---|---|
| Metal | Magnetic | Fe, Si, B, C, Cr | Fe, Si, B, C, Cr | Fe, Si, B, C, Cr |
| magnetic | powder | | | |
| particles | Steel type | Amorphous alloy | Amorphous alloy | Amorphous alloy |
| | Concentration | 80% | 80% | 80% |
| | wt % | | | |
| Ionic liquid | Cation | 4,4′-bis(1,1-dimethylethyl)- | 1,1′-bis[1- | 1′-[bis(1,1- |
| | | 1,1′,2,2′- | (diphenylphosphino)-1- | dimethylethyl)phosphino]- |
| | | tetrakis(diphenyl- | methylethyl]ferrocene | 1,2,3,4,5-pentaphenyl- |
| | | phosphino)ferrocene | | ferrocene |
| | | CAS number: | CAS number: | CAS number: |
| | | 403815-19-0 | 109313-83-9 | 312959-24-3 |
| | Anion | Hexafluorophosphoric | Tetrafluoroboric | Hexafluorophosphoric |
| | | acid | acid | acid |
| | | CAS number: | CAS number: | CAS number: |
| | | 189114-61-2 | 14104-20-2 | 189114-61-2 |
| | Concentration | 20% | 20% | 20% |
| | wt % | | | |
| | Ionic strength | 2.8 | 4.3 | 5.3 |
| | mol/L | | | |
| Physical | Boiling Point | AA | A | A |
| Properties of | Freezing point | A | A | A |
| Magnetic Fluid | Yield stress | AA | AA | AA |
| Composition | Comprehensive | X | X | X |
| | evaluation | | | |

TABLE 4

| | | Comparative | Comparative | Comparative | Comparative | Comparative |
|---|---|---|---|---|---|---|
| | Items | Example 1 | Example 2 | Example 3 | Example 4 | Example 5 |
| Metal | Magnetic | Fe, Si, B, C, Cr | Fe, Si, B, C, Cr | Fe, Si, B, C, Cr | Fe, Si, B, C, Cr | Fe, Si, B, C, Cr |
| magnetic | powder | | | | | |
| particles | Steel type | Amorphous alloy | Amorphous alloy | Amorphous alloy | Amorphous alloy | Amorphous alloy |
| | Concentration | 80% | 80% | 80% | 80% | 80% |
| | wt % | | | | | |
| Ionic liquid | Cation | Ferrocene | Butyl ferrocene | Dimethyl | 1,1′- | Bis(cyclopentadienyl)magnesium |
| | | | | titanocene | dibutylferrocene | |
| | | CAS number: | CAS number: | CAS number: | CAS number: | CAS number: 1284-72-6 |
| | | 31904-29-7 | 31904-29-7 | 1271-66-5 | 1274-08-4 | |
| | Anion | Mineral oil | Dicyanamide | Tetrafluoroboric | Nitric acid | Bis(trifluoromethane |
| | | | | acid | | sulfonyl)imide |
| | | — | CAS number: | CAS number: | CAS number: | CAS number: 189114-61-2 |
| | | | 1934-75-4 | 189114-61-2 | 7697-37-2 | |
| | Concentration | 20% | 20% | 20% | 20% | 20% |
| | wt % | | | | | |
| | Ionic strength | — | 9.6 | 5.9 | 14.1 | 8.7 |
| | mol/L | | | | | |
| Physical | Boiling point | C | C | C | C | B |
| Properties | Freezing point | C | C | C | C | B |
| of Magnetic | Yield stress | C | C | C | C | C |
| Fluid | Comprehensive | Z | Z | Z | Z | Z |
| Composition | evaluation | | | | | |

TABLE 5

| | | Comparative | Comparative | Comparative | Comparative |
|---|---|---|---|---|---|
| | Items | Example 6 | Example 7 | Example 8 | Example 9 |
| Metal | Magnetic | Fe, Si, B, C, Cr | Fe, Si, B, C, Cr | Fe, Si, B, C, Cr | Fe, Si, B, C, Cr |
| magnetic | powder | | | | |
| particles | Steel type | Amorphous alloy | Amorphous alloy | Amorphous alloy | Amorphous alloy |
| | Concentration | 80% | 80% | 80% | 80% |
| | wt % | | | | |
| Ionic liquid | Cation | 2-aminomalonic | 2-amino-3-(3- | 4′-ethoxybenzylidene- | 4′-ethoxybenzylidene- |
| | | acid | methylimidazole-3-ium- | 4-butylaniline | 4-butylaniline |
| | | | 1-yl)propanoic acid | | |
| | | CAS number: | CAS number: | CAS number: | CAS number: |
| | | 1068-84-4 | 1030305-91-9 | 29743-08-6 | 29743-08-6 |
| | Anion | Tetrachloroferrate | Tetrachloroferrate | Tetrachloroferrate | Dysprosium chloride |
| | | CAS number: | CAS number: | CAS number: | CAS number: |
| | | 359845-21-9 | 359845-21-9 | 359845-21-9 | 15059-52-6 |
| | Concentration | 20% | 20% | 20% | 20% |
| | wt % | | | | |
| | Ionic strength | 6.7 | 5.5 | 4.3 | 3.6 |
| | mol/L | | | | |
| Physical | Boiling point | C | C | B | B |
| Properties of | Freezing point | C | C | C | C |
| Magnetic | Yield stress | C | C | C | B |
| Fluid | Comprehensive | Z | Z | Z | Z |
| Composition | evaluation | | | | |

As indicated in the above results, it was confirmed that, in the magnetic fluid compositions of Examples 1 to 10 containing the ionic liquid in which the predetermined cationic group and the predetermined anionic group were combined, all the comprehensive evaluations were Y or more, a high braking force was able to be implemented, and the magnetic fluid composition was less likely to be affected by the surrounding environmental temperature.

Although ferrocene was used as the cation, Comparative Example 1 to which the mineral oil was added was all evaluated as C.

In Comparative Examples 2 and 4 in which ferrocene was used as the cation and was combined with an anion having a low boiling point, it was confirmed that the heat resistance decreased and the yield stress decreased.

Comparative Example 3 in which unstable titanocene in the metallocene was used as the cation was all evaluated as C.

In Comparative Example 5 in which a cation containing Mg, which is a non-magnetic metal, was used, the yield stress was evaluated as C.

All of Comparative Examples 6 to 9 in which the combination of the cation and the anion did not satisfy the present disclosure were evaluated as C.

What is claimed is:

1. A magnetic fluid composition comprising:
a metal magnetic particle; and
a magnetic ionic liquid, wherein
the ionic liquid contains a cationic group and an anionic group,
the cationic group is a metallocene ion,
a central metal of the metallocene ion is one selected from the group including V, Cr, Mn, Fe, Co, and Ru, and
the anionic group is one or more selected from the group including a tetrafluoroborate ion, a hexafluorophosphate ion, a trifluoromethanesulfonate ion, and a bis(trifluoromethanesulfonyl)amide ion.

2. The magnetic fluid composition according to claim 1, wherein
the central metal is Fe.

3. The magnetic fluid composition according to claim 1, wherein
the anionic group is a tetrafluoroborate ion or a hexafluorophosphate ion.

4. The magnetic fluid composition according to claim 1, wherein
the ionic liquid has an ionic strength of less than 6 mol/L.

5. The magnetic fluid composition according to claim 1, wherein
the magnetic fluid composition has a yield stress of 15 kPa or more when being applied with a magnetic field of 0.6 T.

6. The magnetic fluid composition according to claim 1, wherein
the magnetic fluid composition has a boiling point of 250° C. or higher.
